(19) United States
(12) Patent Application Publication
(10) Pub. No.: US 2025/0162841 A1
(43) Pub. Date: May 22, 2025

(54) A NEW SYSTEM FOR FIXING CONTAINERS DURING HANDLING AND PREVENTING THEM FROM SWINGING

(71) Applicant: Osama Ahmed Mohamed Foad MOHAMED, Alexandria (EG)

(72) Inventor: Osama Ahmed Mohamed Foad MOHAMED, Alexandria (EG)

(21) Appl. No.: 18/842,414

(22) PCT Filed: Feb. 2, 2022
(86) PCT No.: PCT/EG2022/000002

§ 371 Date: Aug. 29, 2024

(51) Int. Cl. B66C 13/06

(52) U.S. Cl. CPC B66C 13/06

(57) ABSTRACT

The present invention relates to a system for fixing containers during handling and preventing them from swinging. The system of the present invention is characterized by the use of six wires instead of the eight wires used in the current systems to work on changing the movement of the tips of the spreader inward instead of outward. The system works to change the direction of movement of the spreader from the outside to the inside, by shifting the movement to the four sides of the spreader while tightening the wires towards the middle of the spreader in both horizontal and vertical directions.

### TECHNICAL FIELD

The present invention relates to the field of cranes and container transport, systems for fixing containers during their handling, especially container clamping mechanisms and anti-swinging and anti-vibration mechanisms for container cranes of extremely high tonnages and weights.

### BACKGROUND ART

The present invention relates to the field of cranes and container transport, especially container clamping mechanisms and anti-swinging and anti-vibration mechanisms for container cranes of extremely high tonnages and weights, using a new system that differs from the traditional methods recognized in this field, or described in prior art documents for this purpose. To stabilize the containers and prevent them from swinging during handling, a system of 8 wires (steel ropes) or more was used to install the “spreader” that moves the container to stabilize it significantly and prevent it from swinging. However, this system failed to stabilize the containers and did not prevent them from swinging.

Also, the traditional methods accepted in the field of cranes and container transport, especially the mechanisms of preventing and anti-swinging and anti-vibration; depend on placing the anti-swinging agents in the middle or middle of the “spreader” in the horizontal and vertical positions, making the direction of movement outward. These mechanisms also did not succeed in stabilizing the containers and preventing them from swinging.

The technical problem of the traditional and conventional methods used in the anti-swinging and anti-vibration mechanisms of container cranes is evident in several points:
First: The use of a large number of wires that may reach 8 wires (steel ropes) or more, in order to install the “spreader” that transports the container and to prevent it from swinging significantly, and at the present time it uses 8 wires, which is the least number of wires (steel ropes) reached Modern anti-swinging methods for the purpose of stabilizing containers and preventing them from swinging.
Second: The Prior art designs all depend on placing the anti-swinging in the middle of the “spreader” in the horizontal and vertical positions, which makes the direction of movement outward, which in turn does not stop or prevent the swing completely, but this process requires a period of time.
Third: The presence of anti-swinging devices in the middle or middle of the “spreader” does not sufficiently stabilize the sides of the “spreader” ORPD, as it leaves them free to move, making them free to move, so we find them oscillating greatly in the horizontal and vertical positions, where the direction of movement is outward from the two sides.

### DISCLOSURE OF THE INVENTION

Container cranes are one of the main factors in the container dock, so today, the rapid development of the container crane industries, and how to improve their operational efficiency, and the developments used in the mechanisms of preventing and anti-swinging and anti-vibration mechanisms for container lifts is the main issue that every port is concerned with and studies and tries to develop, So in order to solve the above technical issues or shortcomings, the disclosure of the present invention, which includes an anti-swinging mechanism for container lifters, contains the following points:
1—The present invention provides the number of wires (steel ropes) used in order to prevent or reduce swing, where the present invention includes only 6 wires (steel ropes), which is less than what was achieved by the latest anti-swing methods which is 8 wires (steel ropes) or more.
2—Also, the disclosure of the current invention changes the direction of movement of the “spreader” to make it inward instead of outward, and thus prevents the freedom of movement of the four sides of the “spreader” in the horizontal and vertical positions, by changing the places of the wires (steel ropes) to become on the outer sides of the spreaders, unlike traditional methods that put anti-swingers in the middle or center of the spreader, leaving them free to move.
3—The present invention reduces the time taken to stop or prevent oscillation completely, as the anti-swingers of the present invention take much less time than those of the conventional methods mentioned in the prior art documents.
4—The present invention is distinguished from its counterpart in the designs of the prior art by its ability to increase the number of containers to one or more containers in one row.

This point is a shortcoming in the designs of the prior art due to the long distance between the two pulleys to 4 meters to achieve stability and stability during the process of transporting containers.

On the contrary, in the present invention, the distance between the two pulleys is reduced to 3 meters or less, and thus the spreader can carry out the process of transporting containers and placing them again more efficiently than the designs of the prior art

### DETAILED DESCRIPTION

The disclosure of the present invention, comprising an anti-swing mechanism for container lifters, wherein 4 wires (steel ropes) are used as anti-sway in the vertical position of the “spreader”, while 2 wires (steel ropes) are used only, as anti-swings in the horizontal position of the “spreader”, As follows:

First: Anti-swaying in the vertical position: Four wires (steel ropes) hanging from the control room (machine room) are used to stop or prevent swings in the vertical position as shown on the formal drawings.
1—The wire (steel rope) No. (A1) tightens the side (O) with the Tensioner No. (C1) by the weight of the container inward to the middle towards the disk No. (B1).
2—The wire (steel rope) No. (A2) tightens the side (R) with the Tensioner No. (C2) by the weight of the container inward to the middle towards the disk No. (B2).

Thus, there are two forces from the wire (steel rope) No. (A1)+(A2), that attract the sides (O) and (R) to the middle towards the disks (B1) and (B2), which leads to the prevention of vertical swing of this part completely.
3—The wire (steel rope) No. (A3) tightens the side (P) with the Tensioner No. (C3) by the weight of the container inward to the middle towards the disk No. (B3).
4—The wire (steel rope) No. (A4) tightens the side (D) with the Tensioner No. (C4) by the weight of the container inward to the middle towards the disk No. (B4).

Thus, there are two forces from the wire (steel rope) No. (A3)+(A4), that attract the sides (P) and (D) to the middle towards the disks (B3) and (B4), which leads to the prevention of vertical swing of this part completely.

Second: Anti-swaying in the horizontal position: Only two wires (steel ropes) hanging from the control room (machine room) are used to stop or prevent swings in the vertical position as shown on the formal drawings.
1—The wire (steel rope) No. (A5) tightens the side (F) with the Tensioner No. (C5) by the weight of the container inward to the middle towards the disk No. (B5).
2—The wire (steel rope) No. (A6) tightens the side (L) with the Tensioner No. (C6) by the weight of the container inward to the middle towards the disk No. (B6).

Thus, there are two forces from the wire (steel rope) No. (A5), and the wire or steel rope No. (A6), they attract the sides (F) and (L) to the middle towards the disks (B5) and (B6), which leads to the prevention of horizontal swing of this part completely.

The new position of the anti-swingers, which is now on the outer sides of the spreader instead of in the middle, changes the direction of movement of the spreader and makes it inward instead of outward, thus preventing the freedom of movement of the sides of the spreader by tightening the sides of the “spreader” with wires (steel ropes) to the middle of the spreader in both horizontal and vertical positions as shown on the formal drawings.

### Exploitation Method

When the container is lifted, each wire (steel rope) pulls its own (disc) upward, by the weight of the container, where (the disk) in turn attracts the other sides of the wire (steel rope) connected to the (Tensioner) at the side of the “spreader”.

The (disc) and we refer to it as (B) in the formal drawing is a steel round disc. (See drawings 5-6).

The (disc) contains two holes, the first hole (M) that connects to (the wires) that hangs from the control room, and the second hole (N) connects to the other part of the (the wire) to connect it to the (Tensioner) indicated by the symbol (C).

In the middle (the disc) in a horizontal position (a strip) of steel (K), located on the steel disk, it is located below it in a vertical position (bar) of steel installed in the body of the “spreader” (E) connected to the middle of the (disc) where this (bar) with (the strip) to act as a “brake”.

These “brakes” work to prevent the “wires” from hanging down after the completion of placing the container, due to the special weight of the wires that makes (the strip) and (the bar) meet together, which prevents the movement of the (disc) and thus prevents it from returning to its normal position again, after Finish lifting the container, (see formal drawing No. 5-6).

Each end of the sides (O, R, P, L, F, D) is pulled by wires (steel ropes) to the middle of the spreader, so the direction of movement becomes to the middle of the “spreader”, which means that the direction of movement is inward instead of out (as it is in the traditional methods of the previous art means) which in turn prevents the oscillation completely and permanently.

This leads to easy control of the spreader, which in turn allows the driver to easily carry the container regardless of its weight or load

On the contrary, the greater the weight and load of the container, the higher the degree of stability of the spreader, which is the same when looking at the strength or intensity of the wind.

This design is considered wind-resistant, which leads to a reduction in the time used to transport and place containers in their places.

This is in addition to the ease of organizing, placing and stowing containers in a proper and fast manner, as well as increasing safety when placing containers on top of each other, reducing the rate of accidents resulting from containers falling or not placing them in the appropriate places due to continuous swing or vibration, and reducing the time of organizing. The containers are on top of each other resulting from the new system due to the present invention.

### BRIEF DESCRIPTION OF DRAWINGS

(A) Steel wires or ropes used to prevent swinging; their number is 6.

(B) A round disc of steel, through which the 6 steel wires or ropes pass.

(C) The Tensioner that fixes the wires or steel ropes to the sides of the spreader, and their number are 6.

(O, R, P, L, F, D) The sides or sides of the “spreader” are 6.

(M) The first hole that connects to the wire that hangs from the control room.

(N) The second hole connects to the other part of the (wire) to connect it to the Tensioner.

(k) A steel strip attached to the disc in a horizontal position.

(E) A steel bar connected to the disk in a vertical position that connects the (disc) to the body of the “spreader” and in turn acts as a brake when it meets the (bar), which prevents the movement of the (disc) and prevents its return to its normal position again, after the completion of lifting the container, and prevents the wires from prolapse or hanging down.

FIG. 1 shows the description of the container carrier after placing the anti-swingers of the present invention in their new position on the sides.

FIG. 2 shows the description of the container carrier after placing the anti-swingers of the present invention in their new position on the sides.

FIG. 3 shows the description of the container carrier after placing the anti-swingers of the present invention in their new position on the sides.

FIG. 4 shows the description of the container carrier after placing the anti-swingers of the present invention in their new position on the sides.

FIG. 5 shows the special shape of the round metal disk and shows all its component parts in the first position, which is the normal position without the weight of the container, when the container is lifted.

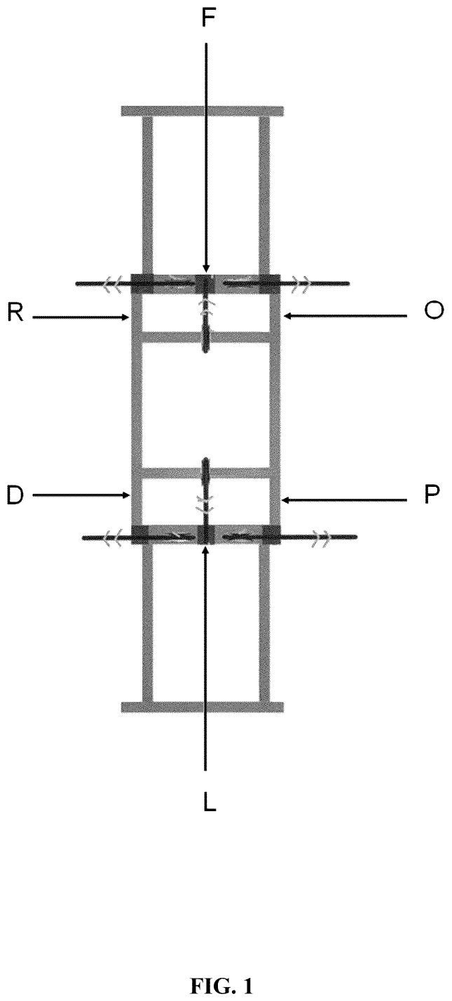

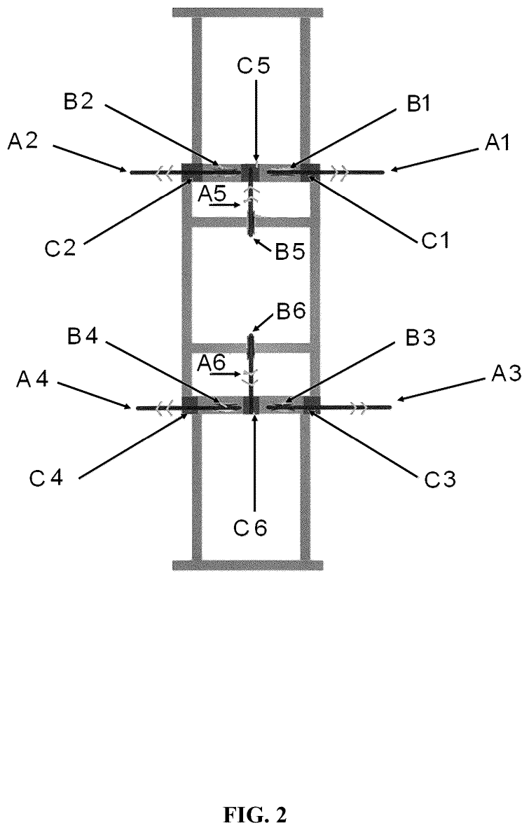

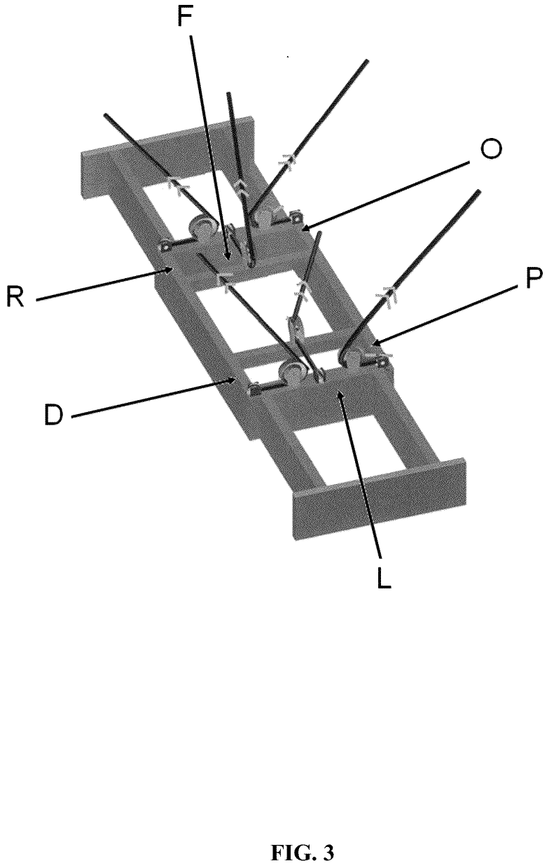

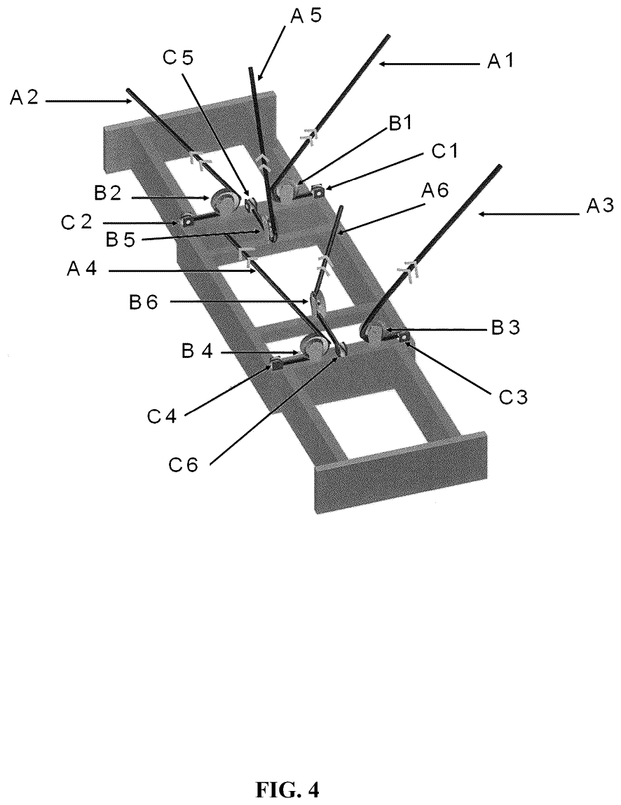

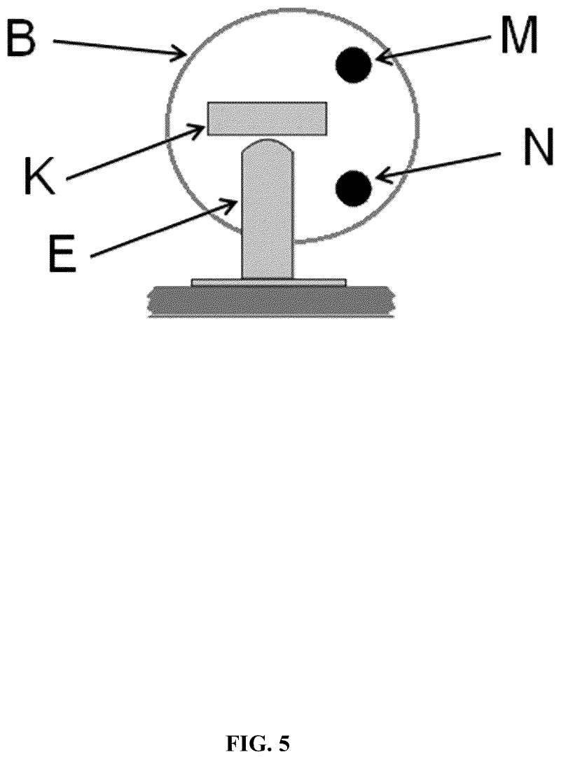

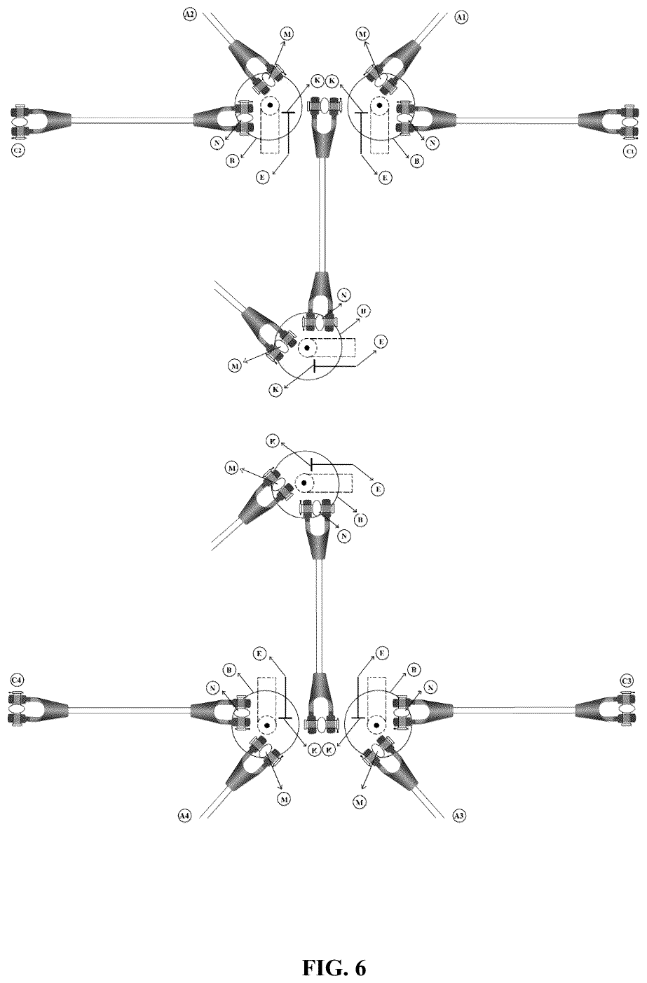

FIG. 6 shows the special shape of the round metal disk and shows all its component parts in the second position when lifting the container and also shows the meeting of the (bar) and (the strip) and acting as brakes in order to prevent the return of the (disc) to the first position again.
What is claimed is:

1-7. (canceled)

8. A system where wire No. Al tightens side O with the Tensioner No. C1 with the effect of pushing the weight of the container inward to the middle at the round metal disk No. B1. And,
wire No. A2 tightens the side R by the Tensioner No. C2 with the effect of pushing the weight of the container inward to the middle at the round metal disk No. B2.
As a result of this tension two forces are produced, wire force A1+wire force A2 attracting side O and side R to the middle at round metal disk B1 and round metal disk B2, which stops the vertical swing.
On the other hand, wire No. A3 tightens side P with the Tensioner No. C3 with the effect of pushing the weight of the container inward to the middle at the round metal disk No. B3.
And, wire No. A4 tightens the side D by the Tensioner No. C4 with the effect of pushing the weight of the container inward to the middle at the round metal disk No. B4.
As a result of this tension two forces are produced, wire force A3+wire force A4 attracting side P and side D to the middle at round metal disk B3 and round metal disk B4, which stops the vertical swing.

9. A system according to claim 1, wire No. A5 tightens side F with the Tensioner No. C5 with the effect of pushing the weight of the container inward to the middle at the round metal disk No. B5.
And,
wire No. A6 tightens side L with the Tensioner No. C6 with the effect of pushing the weight of the container inward to the middle at the round metal disk No. B6.
As a result of this tension, two forces from wire A5 and wire A6 are produced that attract side F and side L to the middle at round metal disk B5 and round metal disk B6, causing the horizontal swing to stop completely.

10. A system according to claim 1, where the vertical tensile forces according to claim No. 2 are integrated with the horizontal tensile forces to completely stabilize the container and prevent it from swinging horizontally and vertically.

11. A system according to claim 1 as described in this statement, with reference to the attached formal drawing.
